(19) United States
(12) Patent Application Publication
(10) Pub. No.: US 2016/0078578 A1
(43) Pub. Date: Mar. 17, 2016

(54) SYSTEM AND METHOD FOR HEALTH CARE MANAGEMENT

(71) Applicant: Srinivas TUMMA, Telangana (IN)

(72) Inventor: Srinivas TUMMA, Telangana (IN)

(21) Appl. No.: 14/847,120

(22) Filed: Sep. 8, 2015

(30) Foreign Application Priority Data
Sep. 15, 2014 (IN) 4496/CHE/2014

(51) Int. Cl. G06Q 50/22; G06F 19/00; G06Q 10/00

(52) U.S. Cl. CPC G06Q 50/22; G06Q 10/00; G06F 19/3418

(57) ABSTRACT

A system for health care management includes a user interface capable of being used by different stake holders in the system. A plurality of first platforms communicate with the user interface and enable the different stake holders to access the user interface and its portal. The user interface enables the different stake holders to view, add, retrieve, and edit a plurality of information in the portal. A central server communicates with the user interface and is populated with the plurality of information of interest to the different stake holders. The different stake holders include a user requiring medical attention, an authorized representative of the user requiring the medical attention, health care providers, emergency health care service providers, transport providers, and accommodation providers. The user interface enables different stake holders excluding the user requiring medical attention to integrate their services and provide service to the user requiring medical attention.

### FIELD OF INVENTION

The present invention is directed to a system and a method for health care management. More particularly the present invention is directed to a system and a method for online health care management that is aimed to connect/unite the health care industry with e-commerce.

### BACKGROUND OF INVENTION

Trying to stay fit and healthy is challenge enough. Another daunting challenge faced by individuals/organizations and health care providers is keeping track of the health care records, expenses, insurance policies, variety of advances in the health care field in terms of products and services, etc . . . Most individuals/organizations/health care providers keep track of the health records by maintaining personal health records either in the hard document form or as is more prevalent today in e-document form. However most of these records are accessible only with a particular individual/organization/health care provider and are quite cumbersome to access, especially during emergencies. For example, visiting a hospital or a doctor may be quite a stressful experience, particularly in situations where an individual is weak from illness or a trauma, or is in a place/time they don't know, and things may be confusing. One may not be able to remember every important detail of their health status and may not be carrying their personal health records as it is not a planned appointment at the hospital. This at times may result in setting up of faulty treatment regime based on incorrect diagnosis. Compounded with this are handling matters related to billing, scheduling of appointments, reminder for health check-up/appointments, medical record sharing, second opinion services, insurance, etc . . .

Keeping track of latest medical advancements, new products and services in the medical industry is another key challenge faced by health care providers. Even individuals with known medical issues may like to keep themselves aware of the advances in the medical field without being inundated with a lot of information.

Another issue that needs to be addressed is health care fraud. These frauds translate into financial losses for both companies/organizations and individuals. Individual victims of health care fraud are sadly easy to find. These are people who are exploited and are subjected to unnecessary or unsafe medical procedures, and at times are provided with useless insurance policies. Some individuals have their medical records compromised or have their legitimate insurance information used by others to submit falsified claims. Thus, ensuring appropriate use of individual's health and personal information is another issue staring the individuals, the health care industry, and insurance industry in their face.

Thus there is a need for an improved system and a method for health care management that is capable of integrating information on a set of comprehensive features with reference to health care needs for individuals/organizations/heath care providers and providing the set of comprehensive features under one umbrella.

### SUMMARY OF INVENTION

In one embodiment, is provided, a system for health care management. The system includes a user interface. The user interface is capable of being used by different stake holders in the system for health care management. A plurality of first platforms may be in communication with the user interface. The first platforms enable the different stake holders to access the user interface. The user interface provides a portal. The user interface enables the different stake holders to view, add, retrieve, and edit a plurality of information in the portal. A central server may be in communication with the user interface. The central server is populated with the plurality of information of interest to the different stake holders. The different stake holders include a user requiring medical attention, an authorised representative of the user requiring the medical attention, health care providers, emergency health care service providers, transport providers, and accommodation providers. The user interface enables the different stake holders excluding the user requiring medical attention to integrate their services and provide service to the user requiring medical attention.

In another embodiment is provided, a system for health care management. The system includes a user interface and a portal. The user interface enables a user requiring medical attention to select a retinue of services from a bank of service providers in the portal. The portal is populated with information on the service providers. The service providers comprise providers of insurance; health care comprising doctors, nurses, and hospital; escort; transport; accommodation; and food. The user interface enables the user requiring medical attention to make a payment. The user interface assists the user requiring medial attention to connect with the selected retinue of services.

By employing the above disclosed system and method processes may be designed and built with the assumption that it may be possible to assist a stake holder/user requiring medical attention to handle health care management information in the central server that will be suitable to their respective need, irrespective of innumerable parameters involved in the health care information.

### BRIEF DESCRIPTION OF FIGURES

FIG. 1 is a schematic illustration representing a system for health care management in accordance with embodiments of the present disclosure;

FIG. 2 is a schematic illustration representing a system for health care management in accordance with embodiments of the present disclosure;

FIG. 3 is a schematic illustration representing a system for health care management in accordance with embodiments of the present disclosure;

FIG. 4 is a schematic illustration representing a system for health care management in accordance with embodiments of the present disclosure;

FIG. 5 is a schematic illustration representing a system for health care management in accordance with embodiments of the present disclosure;

FIG. 6 is a schematic illustration representing a system for health care management in accordance with embodiments of the present disclosure; and

FIG. 7 is a schematic illustration representing a system for health care management in accordance with embodiments of the present disclosure.

### DETAILED DESCRIPTION

Embodiments of the invention as disclosed herein provide an improved system and method for health care management. More particularly the present invention is directed to providing an enabling system and a method for various stakeholders in the health care management industry to manage information of interest to them in an effective manner. The information ranges from personal information of individual patients to information on advances in the medical industry. Each stake holder may use a computer device to access a central server housing the information via a user interface. The disclosure provides a system and method that may assist in uniting the healthcare industry with e-business. Physicians, individuals/patients, organizations employing the individuals, pharmacies, laboratories, hospitals, and insurance companies may utilize this as a one-stop system for health care related information per their requirement. The system disclosed herein attempts to completely integrate various healthcare products and services into a uniform platform. Some features include billing, scheduling, online prescriptions, medical record sharing, second opinion services, proactively alerting the users about the illness prone areas based on medical records and family medical history and latest news on medical advancements and portal features to customize all areas of interest for stake holders who subscribe to or use this system. This cost saving system may help the healthcare industry improve productivity with real-time integrated medical information and with record sharing at or from any location against user authentication. This system may also help in saving many more lives of users who require medical attention in emergency situations, for example, being in an accident on a highway with no hospital or other help at hand. Thus, in various embodiments, the system for health care management disclosed herein attempts to incorporate and integrate the needs of different stake holders who form an integral part of the health care management system.

Accordingly, in one embodiment, is provided a system for health care management. The system includes a user interface. The user interface is capable of being used by different stake holders in the system for health care management. A plurality of first platforms may be in communication with the user interface. The first platforms enable the different stake holders to access the user interface. A central server may be in communication with the user interface. The central server is populated with a plurality of information of interest to the different stake holders. The user interface enables the different stake holders to view, add, retrieve, and edit information in the central server using the first platforms. The different stake holders include a user requiring medical attention, an authorised representative of the user requiring the medical attention, health care providers, emergency health care service providers, transport providers, and accommodation providers. The user interface enables the different stake holders excluding the user requiring medical attention to integrate their services and provide service to the user requiring medical attention.

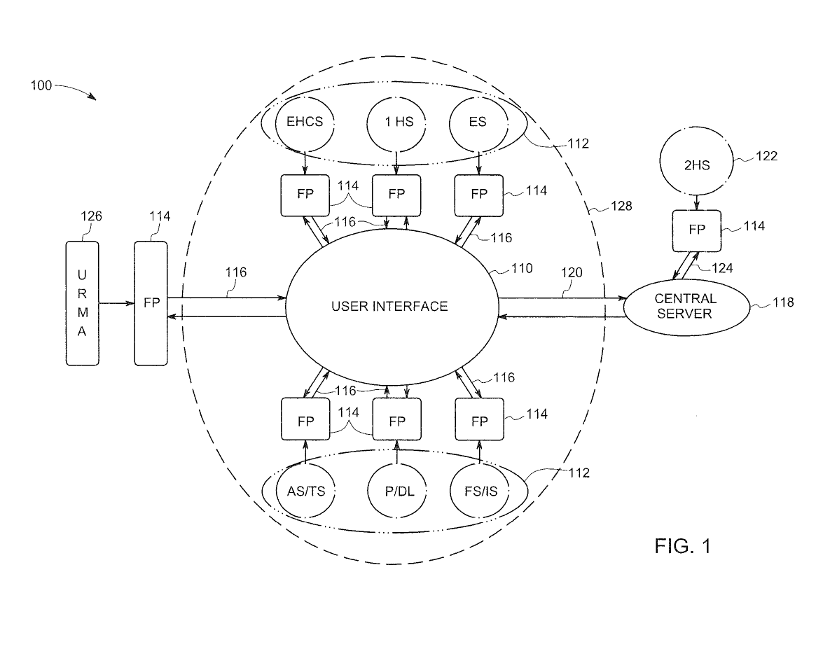

Referring to FIG. 1, a schematic illustration representing a system 100 for health care management in accordance with embodiments of the present disclosure is provided. The system 100 includes a user interface 110 capable of being used by different stake holders 112 in a health care management system. A plurality of first platforms 114 may be in communication 116 with the user interface 110. The first platform 114 may include a computer system including but not limited to a desktop, a laptop, a phone including a mobile phone and a landline, a watch, etc . . . The system 100 includes a portal 128 in communication with the user interface. The different stake holders are enabled to view, add, retrieve, and edit a plurality of information in the portal. The system 100 also includes a central server 118. The central server 118 houses the plurality of information. The central server 118 is in communication 120 with the user interface. The different stake holders 112 may be provided various levels of access to the information. The access may be secured in various manners including passwords, biometrics, physical locking, and the like. Accordingly, the different stake holders 112 may use the user interface 110 accessible through the first platform 114 to view, add, retrieve, and/or edit information in the portal 128. As mentioned herein above different stake holders have restricted access to the portal 128 and the central server 118. The portal 128 may include contact information, availability information, priority information, and the like for the services provided by the different stake holders.

A few stake holders 122 may use their first platform 114 to access information 124 from the central server 118 directly. These stake holders 122 may include those that provide services like second opinion, follow up service, and the like.

One key stake holder is a user requiring medical attention URMA 126 who may access a portal 128 housing the information on different service providing stake holders using the first platform 114 and the user interface 110. URMA 126 may also access the central server 118 using the first platform 114 and the user interface 110.

In one embodiment, the first platform 114 is any device that will enable the different stake holders to access the user interface. Suitable example of the first platform includes, but is not limited to, a phone, a computer, a smart watch, a pad, and a hand held.

The central server 118 may be any server that is capable of housing information with and without restricted access. In one embodiment, the central server may include a cloud computer network. In another embodiment, the central server may be an online portal that includes the necessary services.

In various embodiments the different stake holders may include but are not limited to a user requiring medical attention URMA, an authorised representative of the user requiring the medical attention, health care providers 1HS, emergency health care service EHCS providers, transport TS providers, accommodation AS providers, and the like.

One key stake holder in a health care management system is an individual, i.e., a user requiring medical attention or a patient URMA. In the hectic life style led by most individuals today health takes a back seat for most of us. With reference to health care management, an individual may have various needs including, but not limited to, secure healthcare data accessibility anywhere for the entire life span, time saving appointments, and visits at the physician's or hospitals, customized portal enabled home pages, scheduled hassle free appointments, alerts and supplies ordering, paperless and minimised or zero loss of records and test reports, zero double medication in different prescriptions, updates on latest treatments, medicine availability, suggestion for alternate brand of medicine, etc . . . A company/organization housing these individuals may also be considered as a key stake holder. The pre-employment, post-employment, and annual health check-up records indicating the health status of an employee (an individual/patient) may be made available to the company/organization using this system. This information may be made available only on a need to know basis.

In one embodiment, a stake holder may include healthcare providers 1HS. Healthcare providers include, but are not limited to, hospitals, nurses, physician/doctor, pharmacies, laboratories, and the like. One key stake holder in a health care management system includes a physician or a doctor. With reference to health care management, a physician may have various needs including, but not limited to, complete office automation with centralized real-time patient data, all online accessible information and ordering for medical supplies, cost-effective virtual digital office maintenance, provision for providing electronic prescriptions, pre-defined subjective objective assessment plan notes (H&P notes), and customized portal enabled home page, time-saving, and segregation of duties of facility, multi facility closely integrated management, instant update on changes and cancellation of appointments, and anywhere accept/reject appointment schedules.

Another key stake holder in the healthcare services 1HS includes hospitals. Information on availability of beds, doctors, specialized treatment, pathology labs, medicines and drugs in in house pharmacy, medicine and drugs in neighbourhood pharmacies, complete office automation with centralized real-time patient data, all online accessible information and ordering for medical supplies, cost-effective virtual digital office maintenance, provision for providing electronic prescriptions, and customized portal enabled home page, time-saving, and segregation of duties of facility, multi facility closely integrated management, instant update on changes and cancellation of appointments, and anywhere accept/reject appointment schedules, and the like. In various other embodiments, the needs of the hospitals' may include, but are not limited to complete episode management system, emergency care, intensive care, scheduling rooms, nurse assignment, patient employer and insurance verification online, eliminate calls to physicians, financial accounting management, facility management for multiple hospitals, medical billing and insurance, complete insurance billing and tracking management system, online payment facility, maintaining and tracking detailed records of each individual, and the like services needed in various health care situations.

In one embodiment, the emergency health care service providers EHCS may include any service provider who can assist a user requiring medical attention to get the appropriate services needed in a given medical situation. The emergency health care service providers include, but are not limited to, roadside service providers, ambulatory services, highway clinics, highway emergency service providers, and emergency medical service providers.

In one embodiment, the transport service providers TS may include any transport service provider who can assist a user requiring medical attention to get the appropriate services needed in a given medical situation. The transport service provider may include any convenient mode of transporting a user requiring medical attention to a place of convenience i.e., a place where treatment may be provided, a place where one can rest before treatment may be provided, a place to coalesce after treatment is provided, and the like. The transport service providers may include, but are not limited to, providers of intercity or intracity transports including bus, cabs, flights, trains, and the like.

In one embodiment, the accommodation service providers AS may include any accommodation service provider who can assist a user requiring medical attention to get the appropriate services needed in a given medical situation. The accommodation service provider may include any convenient place of stay for a user requiring medical attention i.e., a place where treatment may be provided, a place where one can rest before treatment may be provided, a place to coalesce after treatment is provided, and the like. The accommodation service providers may include, but are not limited to, hotels, homestays, resorts, medical resorts, and the like.

In one embodiment, the food service providers FS may include any food service provider who can assist a user requiring medical attention to get the appropriate food services needed in a given medical situation. The food service provider may include any convenient mode of providing food to a user requiring medical attention i.e., food served in the place where the user requiring medical attention is accommodated, food suited to the current medical condition of the user requiring medical attention, food services for any person accompanying the user requiring medical attention, and the like. The foodservice providers may include, but are not limited to, home-made food, packaged food, nutrition specific food, nutritionists, and the like.

Other stake holders in a health management system may include, but are not limited to pharmacists P, diagnostic/imaging laboratories DL, hospitals, insurance IS service providers, escort service providers ES (for differently abled or elderly users requiring medical attention), second opinion providers 2HS and information on them, home medical care, and supply services, and medical supply shipment services.

In various embodiments, the needs of the pharmacists and diagnostic/imaging laboratories may include online prescription (legible writing); reduced errors in identification of prescription, minimizing or eliminating calls to physicians to better understand the prescription, time saving, portal enabled home page, and the like

In certain embodiments, the user interface enables the different stake holders excluding the user requiring medical attention to integrate their services and provide service to the user requiring medical attention. In these embodiments, the user interface may enable the user requiring medical attention to register with the user interface and provide access to share their medical records with the different stake holders. The user interface thus enables the different stake holders excluding the user requiring medical attention to integrate their services and provide a tailor made service to the user requiring medical attention.

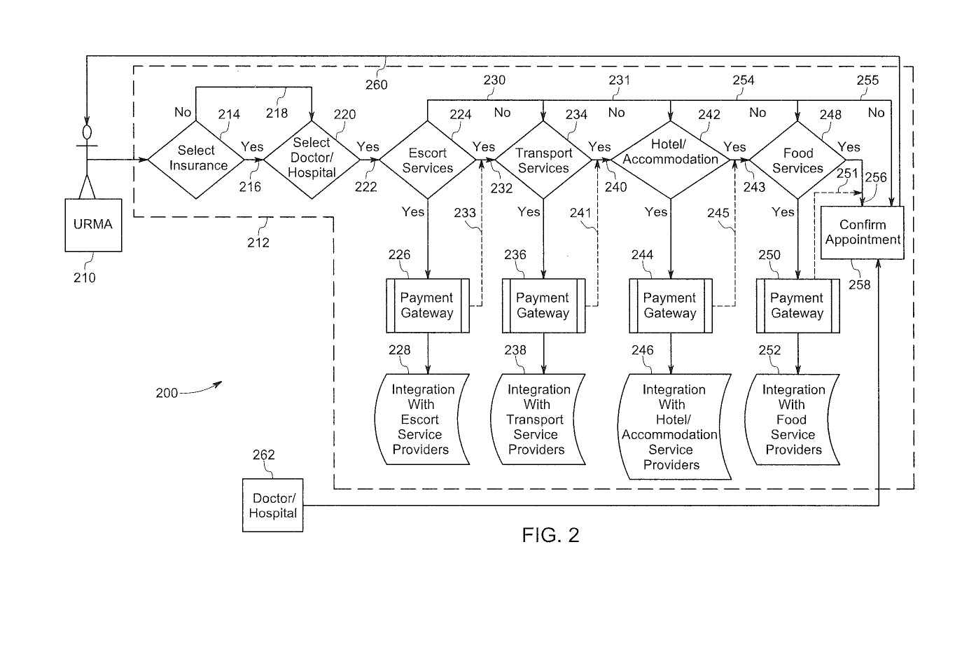

In one embodiment, the user interface 110 provides information on the different stake holders 112 and integration with the different services after the user requiring medical attention 126 completes a payment using a payment gateway provided for by the portal 128. Referring to FIG. 2 is provided is a schematic illustration 200 representing a system for health care management in accordance with embodiments of the present disclosure. A user requiring medical attention URMA 210 may access the portal 212 using a user interface (not shown in figure) and first platform (not shown in figure). The URMA 210 may first select an insurance option 214. Depending on whether the insurance option is available to the URMA 210, ‘YES’ 216 or ‘NO’ 218 the URMA 210 may select a compatible doctor or hospital 220. Once the doctor/hospital 220 is selected and available ‘YES’ 222, URMA 210 may now select the support services required to reach the doctor or hospital, required during stay at the hospital or during treatment with the doctor, and required in the post treatment period with the doctor or at the hospital. Accordingly the URMA 210 may select escort services 222, make a payment using the payment gateway 226 and the user interface (not shown in figure) assists in integrating the URMA's requirement with escort service providers 228. The URMA may then move on 233 to select the transport service if needed ‘YES’ 232 after making the payment at the payment gateway 226. The URMA 210 may use the payment gateway 236 to make the payment for the transport service and the user interface integrates the URMA 210 with the transport service providers 238. The URMA may then select the hotel/accommodation service 242 if needed ‘YES’ 240. The URMA may use the payment gateway 244 to make the payment for the hotel/accommodation service 242 and the user interface integrates the URMA with the hotel/accommodation service providers 246. The URMA may then move on 241 to select the hotel/accommodation service if needed ‘YES’ 240 after making the payment at the payment gateway 236.

The URMA may then select the food service 248 if needed ‘YES’ 243. The URMA may use the payment gateway 250 to make the payment for the food service 248 and the user interface integrates the URMA with the food service providers 252. The URMA may then move on 251 to confirm the appointment ‘YES’ 256 after making the payment at the payment gateway 250.

In certain other embodiments, if the URMA does not require escort services but requires transport service the URMA may select ‘NO’ 230 in the portal for escort services and select ‘YES’ 232 for transport service 234 after selecting the doctor/hospital. The URMA may then use the payment gateway 236 to make the payment for the TRANSPORT service 234 and the user interface integrates the URMA with the TRANSPORT service providers 238. In a similar manner if the URMA does not require escort services 224 and selects ‘NO’ 230 or does not require transport service 234 and selects ‘NO’ 231 and require only hotel/accommodation services 242 the URMA may directly select the hotel/accommodation services 242 after selecting the doctor/hospital. The URMA may then use the payment gateway 244 to make the payment for the hotel/accommodation service 242 and the user interface integrates the URMA with the hotel/accommodation service providers 246. If the URMA does not require escort services 224, transport services 234, and the hotel/accommodation services 242 and requires only the food services 248, the URMA may select ‘NO’ 230, ‘NO’ 231, ‘NO’ 254, and ‘select the food service by using the ‘YES’ 243 option, use the payment gateway 250 to make the payment for the food service 248 and the user interface integrates the URMA with the food service providers 252. The user interface then provides the URMA with a confirmed appointment 258 with the doctor/hospital 262. The URMA may then confirm the request 260. In certain embodiments the URMA may not use any of the services and hence select ‘NO’ 230, ‘NO’ 231, ‘NO’ 254. ‘NO’ 255 and directly confirm the appointment 258 by selecting ‘YES’ 256. Thus, in certain embodiments (not shown in figure) the URMA may select only the confirmation of request service for the doctor/hospital appointment.

In certain embodiments, the URMA may have to see only one payment gateway (not shown in figure) after making all selections instead of seeing multiple payment gateways 224, 236, 244, and 250 for each step in the selection process. Thus the user interface provides the URMA with a flexible portal that makes the URMA have a pleasant experience. The user interface also provides the service providers a platform to advertise/make available their services for the URMA to select from and integrates the URMA's requirement with the services provided by the different stake holders.

In various embodiments, the portal included in the system for health care management disclosed herein enables the integration of service providers to provide a network of certified service providers. For example, a network of certified physicians, a network of certified radiology laboratories, and the like.

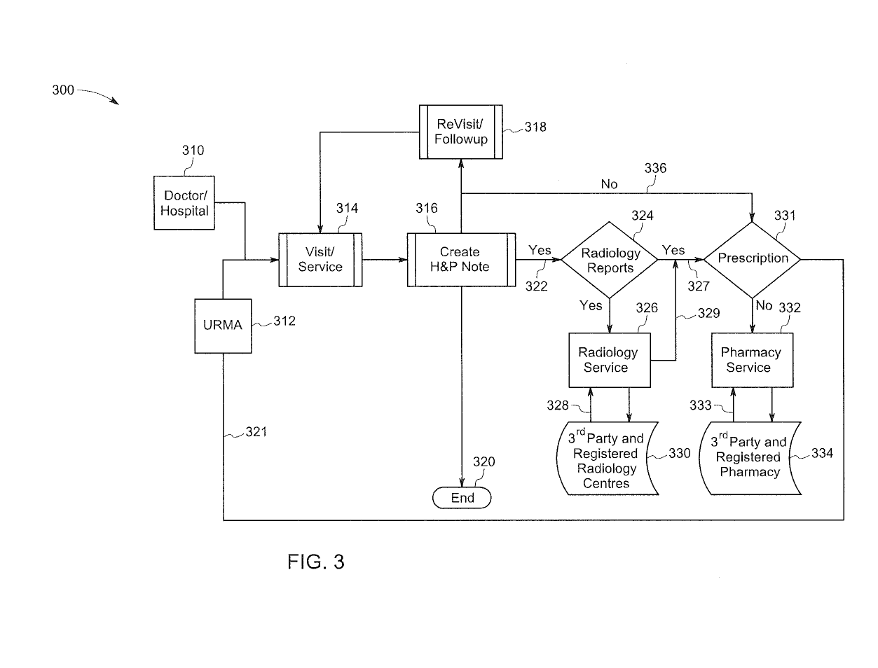

Referring to FIG. 3 a schematic illustration representing a system 300 for health care management in accordance with embodiments of the present disclosure is provided. Once the URMA 312 has got an appointment with the doctor or hospital the URMA either visits the doctor/hospital or a service provider 314. The doctor creates H&P notes 316 (also called as office/clinic notes). In one embodiment, if no prescription is required the visit/service ends here 320. In another embodiment, if any further diagnostics are required ‘YES’ 322 the doctor may direct the URMA to provide radiology reports 324. The URMA may use the user interface (not shown in figure) to select the radiology service providers 326 and the user interface integrates 328 the requirements of the URMA with either registered or un-registered (third party) radiology service providers 330. If any further prescriptions are required ‘YES’ 327 or post the radiology reports 329 the doctor may provide the URMA with prescription 331. The URMA may use the user interface (not shown in figure) to select the pharmacy service providers 332 and the user interface integrates 333 the requirements of the URMA with either registered or un-registered (third party) pharmacy service providers 334. In certain embodiments, the doctor 310 may not require the URMA 312 to either get any further diagnostics or give the URMA 312 any prescription. In the embodiments where the prescription is required the URMA follows a treatment schedule per the prescription 321. The doctor may suggest a revisit/follow up 318 for a check-up. The URMA 312 may again use the user interface to confirm the visit or service 314 and the whole process may be repeated.

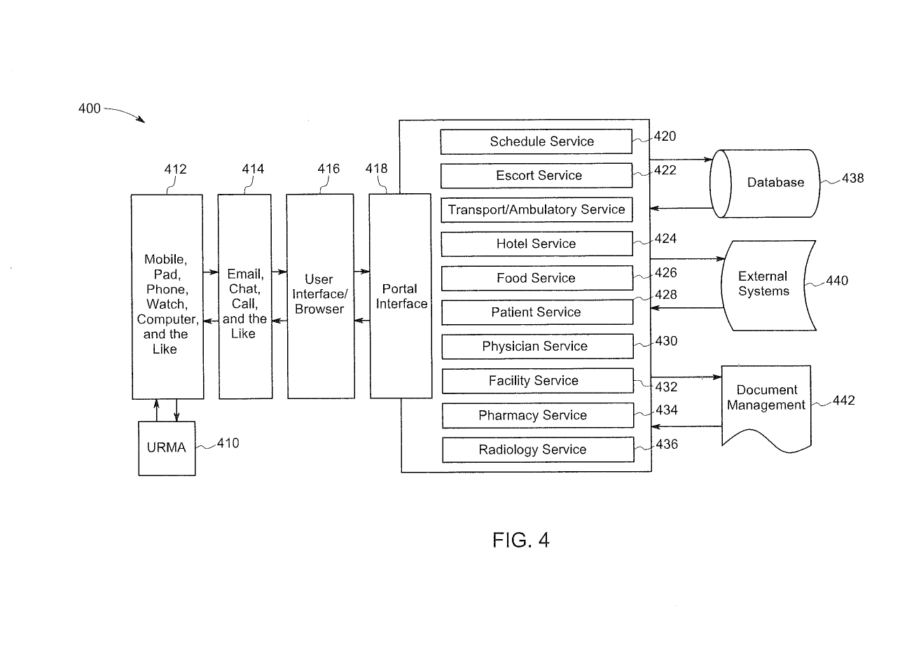

Referring to FIG. 4, a schematic illustration representing a system for health care management in accordance with embodiments of the present disclosure is provided. The system 400 includes a user interface 416 capable of being used by different stake holders i.e., URMA 410, schedule (appointment) service 420, escort service 422, transport/accommodation service 424, hotel service 424, food service 426, patient service 428, physician service 430, faculty service 431, pharmacy service 432, radiology service 434, and the like in the health care management system 400. All the stake holders other than URMA are included in a portal 418 that is accessible by a plurality of first platforms 412, i.e., mobile, pad, phone, watch, computer, and the like that may be in communication 414 with the user interface 416. The different stake holders are enabled to view, add, retrieve, and edit a plurality of information in the portal 418. The system 400 also includes a central server 438 that functions as a database. The system 400 includes access to external systems 440. The external system 440 includes third party portal integration (application programming interfaces API) which allows and enables the accessibility in between central portal and third party portal to access past history and update current updates wherever the vendor/service provider uses their own systems/software to understand patient status and keep the records up to date all the time. This may assist in avoiding manual update of records after visiting non-member service providers.

The system 400 also provides for document management 442 for the various information, reports, charts, etc . . . of the different stake holders. The central server (database) 438 and document management section 442 are in communication with the user interface via the portal. The different stake holders may be provided various levels of access to the information.

The disclosure provides various technical and commercial advantages. In one embodiment, the advantage provided includes complete office automation with centralized real-time relevant patient data. This disclosure includes multi-layer security for confidential details like patient medical history. A patient may determine who can access his records, he/she may share his/her medical records for a specific user or organization on need basis or permanently. The system disclosed herein treats each hospital as a tenant which will allow the physicians and hospitals as working under one portal and at the same time as secured individual and a secured entity in a digital cloud.

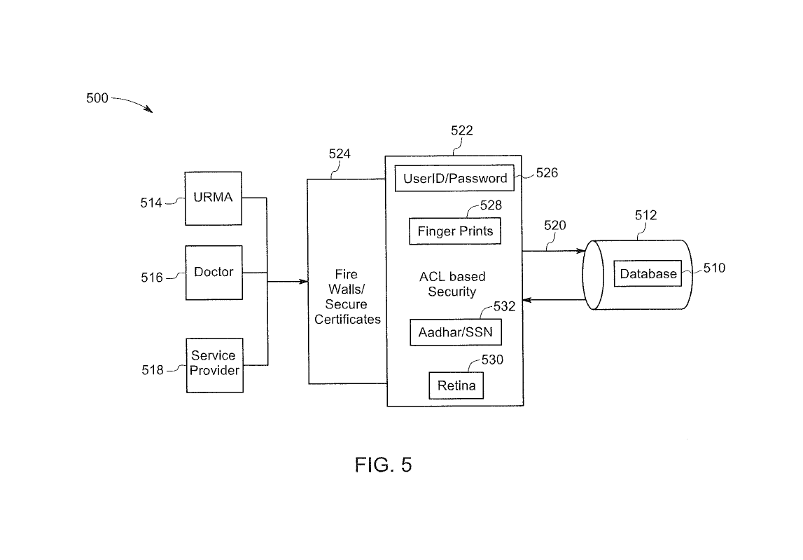

Referring to FIG. 5, a schematic illustration 500 representing a system for health care management in accordance with embodiments of the present disclosure is provided. FIG. 5 represents the security system that the central server includes in protecting the database 510 housed in the central server 512. The URMA 514, the doctor 516, and any other service provider 518 may need to have security clearance to input or access data to/from the database. The secure system 522 may include firewalls or security certificates 524 for allowing a stake holder to access the database 510. The secure system includes user-identity/password 526, biometrics like finger printing 528 and retina scan 530, or government identity like Aadhaar card number or social security number SSN 532.

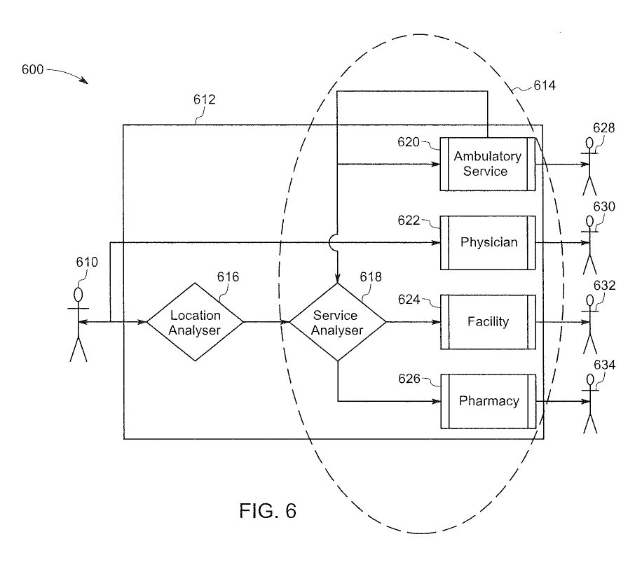

Referring to FIG. 6, a schematic illustration 600 representing a system for health care management in accordance with embodiments of the present disclosure is provided. In FIG. 6 a user interface 612 and a portal 614 enables an URMA 610 in an emergency situation to receive necessary medical attention. The URMA 610 (or any person assisting the URMA) may use the user interface 612 to request for medical attention with minimal use of the first platform, for example, a single button on the mobile handset to send an emergency signal for assistance. The portal 614 includes a location analyser and a service analyser 618. The portal 614 analyses the location and requirement and accordingly alerts required services, for example, an ambulatory service 620, a physician 622, a hospital facility 624, a pharmacy 626, and other required facilities for a given emergency situation. The user interface 612 integrates the requirement of the URMA in an emergency situation 610 to the required service providers, for example, an ambulatory service provider 628, a medical service provider 630, a facility service provider 632 and a pharmacy service provider 634.

In one embodiment, the health care system disclosed herein may enable relevant stake holders in curbing fraud by giving them access to authentic and protected information. The features of the systems are integrated and provide information to different stake holders as per their needs.

In one embodiment, the health care system disclosed herein may enable optimization of the availability of various resources including the doctor, hospital bed, travel, accommodation, and the like. The user interface enables a URMA to optimize the search in the portal. The user interface enables the health care providers to optimize their availability in the portal. For example, if the hospital has empty beds, or a doctor has some free time, or if there is an organ available and the doctor/hospital is unaware of a need recipient, they can post this information on the portal. Thus if a URMA is in the waiting list, or URMA is waiting for a reasonable cost package provided by a health care provider, or URMA is waiting for organ transplant, and the like services they can use the information posted by the hospital and get healthcare at reduced or no cost. This provides a low or no price option for URMA and at the same time the health care providers may generate revenue/good will for time, which may otherwise be unoccupied and lost without any use. The integration provided by the system disclosed herein enables the health care services to fill the availability gaps.

Listed below are various advantages provided by the instant disclosure that may include, but are not limited to, information on entire lifespan records of an individual i.e., birth to death records; family history disclosures; second opinions that avoid the wrong treatment providing savings in both health and money; wrong bills, for example, avoids claiming twice for the same treatment; hassle free medical billing for patient, hospital and insurance companies; rating of physicians and hospitals based on real time experience and other experiences; right qualifications of the physicians and market price for the treatments across the physicians in that area, medical test records with time stamp across the physician facilities—this may assist in avoiding repeating the same tests as and when one changes the physician/ hospital, and host of similar other features.

The system also provides users an interface to access web based consultations. Patients who find time constraints in visiting physicians or are not able to do so since the visit is time sensitive and they cannot reach within time due to long distances or for some other reason, may find it easier to use the system disclosed herein to get consultations from physicians. Particularly for indications where a physical visit to a physician is not warranted i.e., for indications like common fever, cough, etc . . . or for primary diagnosis where visits can be avoided by using the system disclosed herein. In emergency situations where the URMA may not be in a position to visit a doctor, they may use the system disclosed herein to call their doctor. The doctor may advice to take some medicine and then come to the hospital or emergency room.

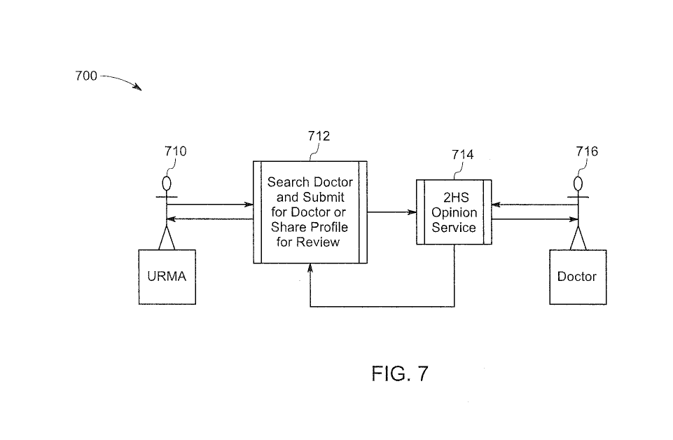

Referring to FIG. 7, a schematic illustration 700 representing a system for health care management in accordance with embodiments of the present disclosure is provided. In FIG. 7 the user interface 712 makes a medical opinion service 714 accessible to URMA 710. The URMA 710 may use the user interface 712 to search for a doctor, submit information to get integrated with an appropriate doctor, or share a profile enabling them to receive service from a doctor. The user interface 712 looks for the relevant medical opinion service provider in the portal 714. The doctor 716 provides a medical opinion 714 based on the information shared by URMA 710 which is recorded in the portal, hence this medical opinion may be termed as 2HS or second medical opinion based on information already store dint eh portal. The user interface 712 extracts the information from the portal and shares the information with the URMA 710. This option may be further extended to telemedicine services. A URMA/or a representative of the URMA may measure his/her blood pressure, temperature, etc . . . and provide the information to a doctor for evaluation. For some physical issues like say rashes, the URMA can go on visual chat or send photographs or scanned images to the doctor for evaluation. The information is included in the central server (not shown in figure) through the user interface (not shown in figure) and the portal (not shown in figure). The doctor may access the information from the portal or the central server and provide online diagnosis and required emergence preliminary/final treatments. If the treatment is preliminary the URMA may have sufficient time to alleviate their initial discomfort due to the medical condition, and then reach a hospital for further treatment. The system also includes the possibility of automated treatment controlled by remote machinery with minimal manual intervention.

The system disclosed herein also integrates and includes in its portal, facilities like drones for reaching medications etc . . . to remote or disaster affected areas. This facility is available for URMA to select and use when needed.

In various other embodiments, the disclosure also includes effective use of social networking sites like Facebook®, Twitter®, LinkedIn™, and Google® to share information and reviews about different hospitals, facilities, new offerings/treatments and medication and alerts, precautionary advises and ratings, expenses, and the like.

The system disclosed herein operates by effectively integrating all the resources needed in a health care system. The system not only links hospitals, doctors, pharmacies, medical testing labs, ambulance services and the like who are the primary resources in a health care system but also links all the support services needed like transport, food, escort, and the like. The system not only addresses health care under normal routine situations but also addresses health care needed under emergency and traumatic situations.

The foregoing embodiments meet the overall objectives of this disclosure as summarized above. However, it will be clearly understood by those skilled in the art that the foregoing description has been made in terms only of the most preferred specific embodiments. Therefore, many other changes and modifications clearly and easily can be made that are also useful improvements and definitely outside the existing art without departing from the scope of the present disclosure, indeed which remain within its very broad overall scope, and which disclosure is to be defined over the existing art by the appended claims.

1. A system for health care management comprising:
a user interface capable of being used by different stake holders in the system for health care management;
a plurality of first platforms in communication with the user interface; wherein the first platforms enable the different stake holders to access the user interface;
a portal in communication with the user interface, wherein the different stake holders are enabled to view, add, retrieve, and edit a plurality of information in the portal;
a central server in communication with the user interface; wherein the central server is populated with the plurality of information;
wherein the different stake holders comprise a user requiring medical attention, an authorised representative of the user requiring the medical attention, health care providers, emergency health care service providers, transport providers, and accommodation providers; and
wherein the user interface enables the different stake holders excluding the user requiring medical attention to integrate their services and provide a service package to the user requiring medical attention.

2. The system for health care management as claimed in claim 1, wherein the first platforms comprise a phone, a computer, or a hand held.

3. The system for health care management as claimed in claim 1, wherein the emergency health care service providers comprise roadside service providers, ambulatory services, highway clinics, highway emergency service providers, or emergency medical service providers.

4. The system for health care management as claimed in claim 1, wherein the user interface enables the user requiring medial attention to register with the user interface.

5. The system for health care management as claimed in claim 4, wherein the user interface enables the different stake holders excluding the user requiring medical attention who has registered with the user interface to integrate their services and provide a tailor made service to the user requiring medical attention.

6. The system for health care management as claimed in claim 1, wherein the user interface enables the service providers to register with the user interface.

7. The system for health care management as claimed in claim 1, wherein the portal enables the integration of service providers to provide a network of certified service providers.

8. A system for health care management comprising:
a user interface;
a portal;
wherein the user interface enables a user requiring medical attention to select a retinue of services from a bank of service providers in the portal;
wherein the portal is populated with information on the service providers;
wherein the service providers comprise providers of insurance; health care comprising doctors, nurses, and hospital; escort; transport; accommodation; and food;
wherein the user interface enables the user requiring medical attention to make a payment; and
wherein the user interface assists the user requiring medial attention to connect with the selected retinue of services.

9. The system for health care management as claimed in claim 8, wherein a central server is in communication with the user interface, and wherein the information is securely stored in the central server.
